(19) United States
(12) Patent Application Publication
(10) Pub. No.: US 2010/0294037 A1
(43) Pub. Date: Nov. 25, 2010

(54) GAUGE ASSEMBLY AND METHODS OF USING SAME

(76) Inventors: David DeLeo, Sayreville, NJ (US); Marcos A. Ortega, Kearny, NJ (US)

Correspondence Address: STROOCK & STROOCK & LAVAN LLP, 180 MAIDEN LANE, NEW YORK, NY, 10038, US

(21) Appl. No.: 12/470,037

(22) Filed: May 21, 2009

(51) Int. Cl. G01F 23/38

(52) U.S. Cl. 73/317

(57) ABSTRACT

A gauge assembly measuring an amount of a liquid, for use with a float arm assembly including a float arm pivoting in response to a change in the level of liquid, and a flange housing a first magnet and coupled to the float arm where the movement of the float arm causes a displacement of the first magnet. The gauge assembly includes a support adapted to be attached to the flange, which includes a second magnet, spaced in relationship to the first magnet and having a different strength than the first magnet, and an electronic circuit positioned proximate to the first and second magnets to provide a signal representative of the position of the second magnet wherein the second magnet is displaced by the first magnet in response to the level of liquid. The gauge assembly includes a display associated with the second magnet for showing the level of liquid.

### FIELD OF THE INVENTION

The present invention relates to the field of measuring levels of liquid; and more particularly to devices for visually and electronically measuring levels of liquid in a tank.

### BACKGROUND OF THE INVENTION

Liquids are stored in tanks in numerous industries. For example, in the electric utilities industry, oil stored in an oil tank is used to help cool a transformer and to provide insulation between internal parts of the transformer that are energized. It is important to maintain a requisite level of oil, since failure to do so may result in a failure of the transformer. Accordingly, many conventional oil tanks that are used with transformers include a conventional gauge assembly that, upon visual inspection, can inform the observer of the level of oil in the tank.

While conventional gauge assemblies, mounted on a mechanical float and magnet assembly, indicate a level of oil in the tank to a person working proximate to such gauge assembly, it is often advantageous to monitor the level of the oil remotely. Accordingly, a device capable of providing on-site monitoring as well as well as transmission of a signal representative of such monitoring, to a remote monitoring station, would be desirable.

### SUMMARY OF THE INVENTION

In one embodiment, there is disclosed a gauge assembly, for measuring an amount of liquid contained in the tank, for use with an existing float arm assembly. The existing float arm assembly includes a float arm partially disposed within the tank and configured to be moved in response to a change in the level of liquid in the tank. The existing float arm assembly further includes a flange that houses a first magnet and is coupled to the float arm such that the movement of the float arm causes a corresponding displacement of the first magnet.

The gauge assembly comprises a support that is adapted to be attached to the flange. The support includes a second magnet, spaced in relationship to the first magnet and having a different strength than the first magnet. The gauge assembly further comprises an electronic circuit positioned proximate to the first magnet and the second magnet to provide a signal representative of the position of the second magnet, wherein the second magnet is displaced by the displacement of the first magnet to show the change of the level of liquid in the tank. The gauge assembly further comprises a display associated with the second magnet for showing the level of liquid in response to the position of the second magnet, and provides a signal representative of the position of the second magnet.

### BRIEF DESCRIPTION OF THE FIGURES

FIG. 1 is a front view of a conventional gauge assembly mounted to a flange with a float arm;

FIG. 2 is an perspective view of a conventional gauge assembly of FIG. 1;

FIG. 3 is an exploded perspective view of a gauge assembly;

FIG. 4 is an exploded perspective view conventional gauge/flange assembly of FIG. 1;

FIG. 5 is a front view of a conventional flange/float arm assembly;

FIG. 6 is a front view of a support of a gauge assembly;

FIG. 7 is a back view of a support of a gauge assembly of FIG. 6;

FIG. 8 is an isometric view of a gauge assembly;

FIG. 9 is a front view of a gauge assembly of FIG. 8; and

FIG. 10 is a perspective view of an embodiment of a gauge assembly.

### DETAILED DESCRIPTION OF THE EMBODIMENTS

Certain embodiments of the present invention will be discussed with reference to the aforementioned figures, wherein like referenced numerals will refer to like components. It should be noted that references in the specification to phrases such as “one embodiment” or “an embodiment” means that a particular feature, structure or characteristic described in connection with the embodiment is included in at least one embodiment of the invention. The phrases such as “in one embodiment” or “in certain embodiments” in various places in the specification are not necessarily, but can be, referring to the same embodiment.

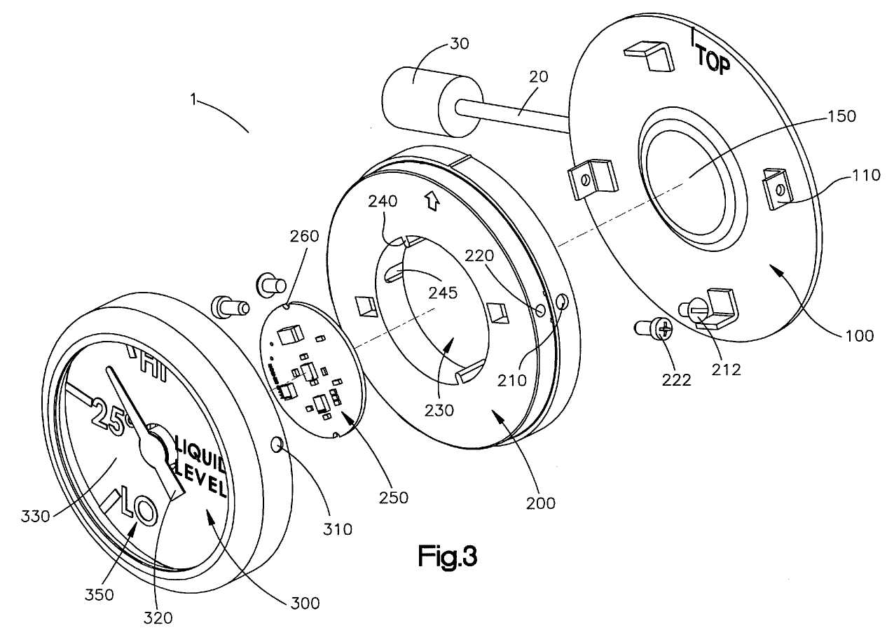

With reference to FIG. 3, according to an embodiment of the invention, in order to permit local visual indication of a level of liquid contained in a tank (not shown), while simultaneously being able to monitor the level remotely, there is shown a side-mount gauge assembly 1, which is attached to a flange 100 and may replace a conventional gauge assembly 10 (in the manner described in further detail below). The gauge assembly 1 preferably includes an adapter 200 having an electronic circuit 250 mounted therein, and a display assembly 300. The adapter 200 is secured to the flange 100 and the display assembly 300 is attached to the adapter 200. The electronic circuit 250 preferably produces a signal that is representative of the level of liquid in the tank and that can be received remotely. The display assembly 300 displays the level of the liquid in the tank and may be observed directly. It should be noted that the invention should not be limited to the precise structure of gauge assembly 1, and in further embodiments the various components can be recombined in alternative structures without departing from the scope of this invention so long as the components of the gauge assembly are supported and arranged such that the electronic circuit is disposed between the magnet of the flange and the magnet of the gauge assembly. For example, the gauge assembly may comprise a single support that includes the magnet, the electronic circuit, and the display.

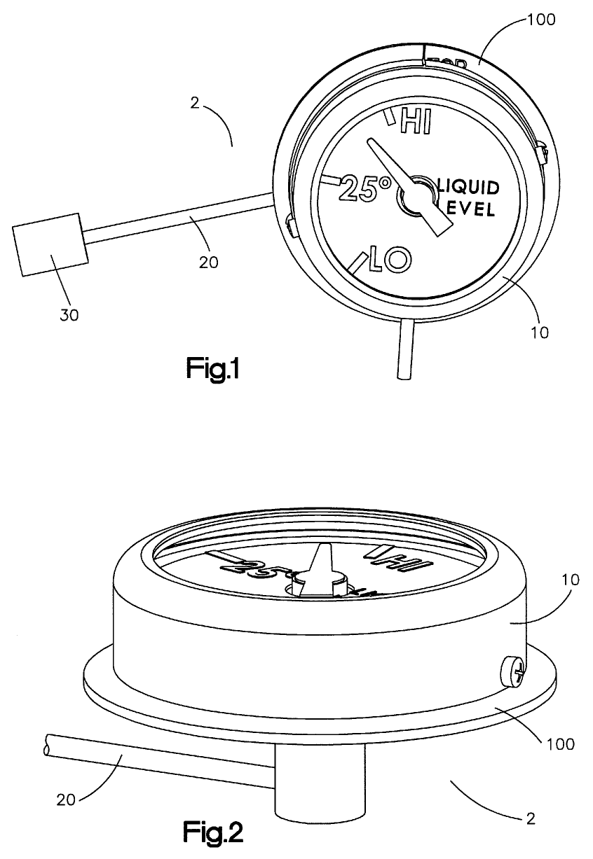

The flange 100 (FIGS. 3-5) may be a conventional flange that houses a magnet 150. In flange 100, the magnet 150 is mechanically coupled to a float arm 20 (FIGS. 1-2) that is partially disposed within the tank containing the liquid to be monitored and includes a float element 30 that floats within the liquid causing the float arm 20 to pivot when there is a change in the level of the liquid. The magnet 150 is preferably housed by the flange 100, behind a non-ferrous plate. The flange 100 preferably includes fastening elements 110 (e.g., mounting ears) that facilitate attachment of a conventional gauge assembly 10 and/or the adapter 200. It should be noted that the invention should not be limited to any particular type of flange or fastening element, and that in further embodiments any type of flange may be utilized so long as it includes a magnet that is displaced in response to a change in the level of liquid in the tank.

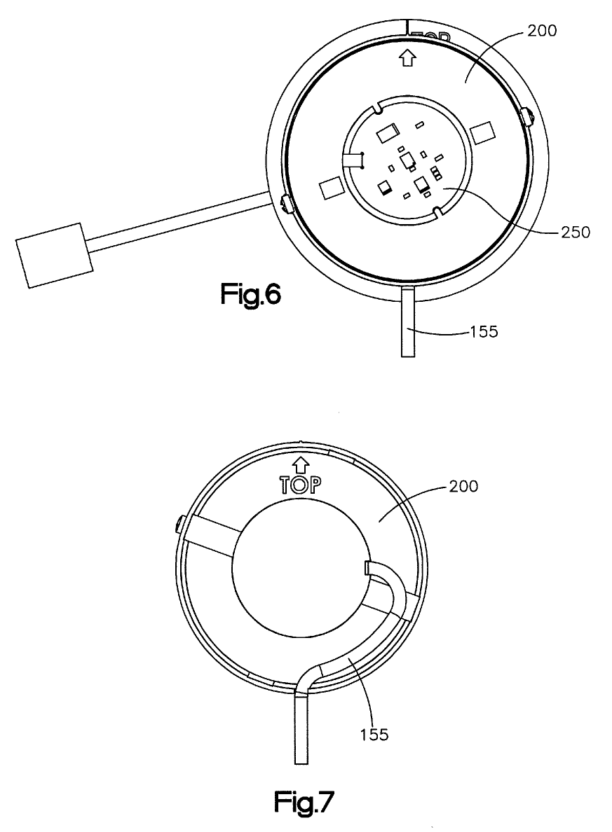

With reference to FIG. 3, The adapter 200 (also shown in FIGS. 6-7), which is attached to the flange 100, is preferably adapted to match to the size of the flange 100 and to attach to the fastening elements 110 (that may have been used to fasten the conventional gauge assembly 10) via matching fastening elements 210 and fasteners 212 such as screws. The adapter 200 preferably further includes fastening elements 220 which would match with fastening elements 310 on the display assembly 300 (described in detail below) to facilitate securing of the display assembly 300 to the adapter 200.

The adapter 200 preferably includes a cavity 230 into which the electronic circuit 250 is mounted. The cavity 230 may include orienting elements, such as protrusions 240, that would assist in orienting and holding in place the electronic circuit 250 circuit (which may be configured with matching orienting elements such, as recesses 260) within the recess 230. The cavity 230 may further include an aperture 245 for passing a cable from the electronic circuit 250 to an external device or network such that the signals from electronic circuit 250 can be monitored remotely. It should be noted that the adapter 200 may take on any size and may be created from any suitable material such as rubber, metal, or plastic, and may be attached to the flange through different elements than those used to attach the conventional gauge assembly 10. In a preferred embodiment, the adapter 200 minimizes the distance between the flange 100 and the display assembly 300. Furthermore, the aperture 245 may not be present if the signal from the electronic circuit is passed wirelessly.

In a preferred embodiment (shown in FIGS. 3, 8, 9), the display assembly 300 is secured to the adapter 200, over the electronic circuit 250 (thereby sandwiching the electronic circuit 250 within adapter 200, between the display assembly 300 and the flange 100), via the matching of the gauge assembly's fastening elements 310 to the support's fastening elements 220, and insertion of fasteners 222, such as screws therethrough. The display assembly 300 preferably includes a display 350 thereon, and a magnet therein. The display 350 may be an analog display having an arrow 320 and a range 330 with the arrow 320 pointing to a position in the range 330 indicative of the current level of liquid in the tank.

The magnet of the display assembly 300 is spaced in relationship to the magnet 150 of flange 100. The magnet of gauge assembly 100 is magnetically coupled to and is displaced by the displacement of the magnet 150 of flange 100. The magnet of the display assembly 300 may be mechanically coupled to the arrow 320, such that displacement of the magnet results in a corresponding displacement of the arrow 320. It should be noted that any type of display 350 may be used with the display assembly 300, for example LED, LCD, or any other type of analog or digital display. In embodiments where the display 300 is digital, the magnet may not be mechanically coupled to a display, and a may detects its position and displacement and output the signal representative thereof to the display.

The electronic circuit 250, which is mounted to the adapter 200, may be any electronics package capable of tracking the displacement of the magnet of display assembly 300 (although in alternate embodiments the electronic circuit 250 may be configured to track the displacement of magnet 150 of the flange 100). Electronic circuit 250 may include a cable connected thereto, through which the electronic circuit 250 can transmit a signal representative of the position of the magnet of display assembly 300, which corresponds to a position of the magnet 150 of flange 100. Beyond the bare ability to track the magnet of display assembly 300 and provide a signal related to such tracking, the electronic circuit 250 may be equipped with microprocessors, memory, and related programming to allow the electronic circuit 250 to perform other relevant functions such as, for example, signal processing, wireless communication, or any other relevant function. The electronic circuit 250 may take on any shape and size so long as it is capable of being mounted to the adapter 200. In further embodiments, electronic circuit 250 and adapter 200 may be a single unit. In a preferred embodiment, the distance between the electronic circuit 250 and the magnet it is tracking is minimized. In an alternate embodiment shown in FIG. 10, the electronic circuit 250 may be adapted to be mounted to the outside of the display assembly 300.

In order to improve the functioning of the gauge assembly 1, the magnet of the display assembly 300 is preferably stronger than the magnet 150 that is contained in the flange 100. One of the difficulties in disposing the electronic circuit 250 proximate to two magnets is the nature of magnets aligned N-S and S-N to form a null in the field between them as a result of the magnetic quadrapole field that is formed. This null field prevents the electronic circuit 250 from properly detecting the position of the magnet of display assembly 300. This difficulty may be overcome through the use of different strength magnets within the display assembly 300 and the flange 100. The use of a stronger magnet not only avoids the null field interference with the electronic circuit 250, but also enhances the magnetic coupling between the magnet of display assembly 300 and the magnet 150 within the flange 100. In a preferred embodiment, the magnet within the display assembly 300 is a rare earth neodymium (NdFeB) magnet that is stronger than the magnet housed within the flange 100. In a preferred embodiment, electronic circuit 250 is disposed between magnet 150 and the magnet within the display assembly 300 and closer to the stronger magnet. It should be noted that the present invention should not be limited to any specific type of magnet, as any type of magnet may be utilized. It should be further noted that in certain embodiments, the stronger magnet may be magnet 150 that is housed in the flange 100.

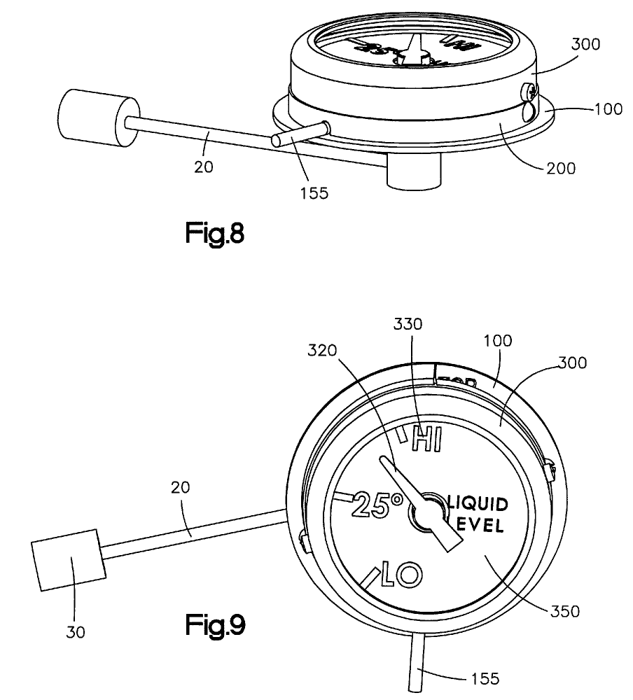

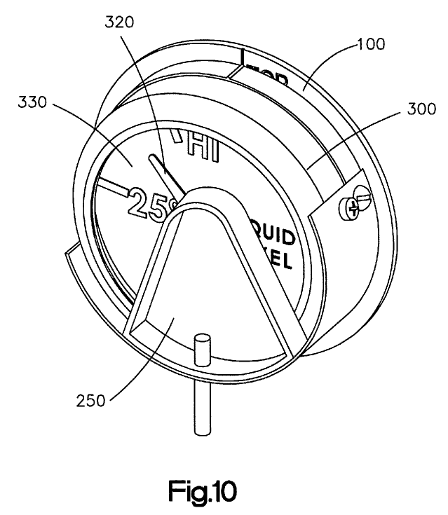

In use of a gauge assembly 1 that is mounted to the flange (FIGS. 8-9), the float element 30 of float arm 20, floats on liquid contained in a tank. A variation in the level of the liquid causes the movement of the float element 30 and a resulting pivoting of the float arm 20 in some direction. The pivoting of the float arm 20, in turn, causes a displacement (e.g., rotation) of the magnet 150 contained in the flange 100. The rotation of magnet 150 causes a similar rotation of the magnet in the display assembly 300, which, in turn, causes a change in the display of display assembly 300, which shows the current level of liquid in the tank. Additionally, the displacement of the magnet in the display assembly 300 is detected by the electronic circuit 250 that is included in the support. The electronic circuit 250 produces a signal representative of the position of the magnet in the display assembly 300 and sends that signal through cable 155 to be received remotely by some monitoring module (not shown).

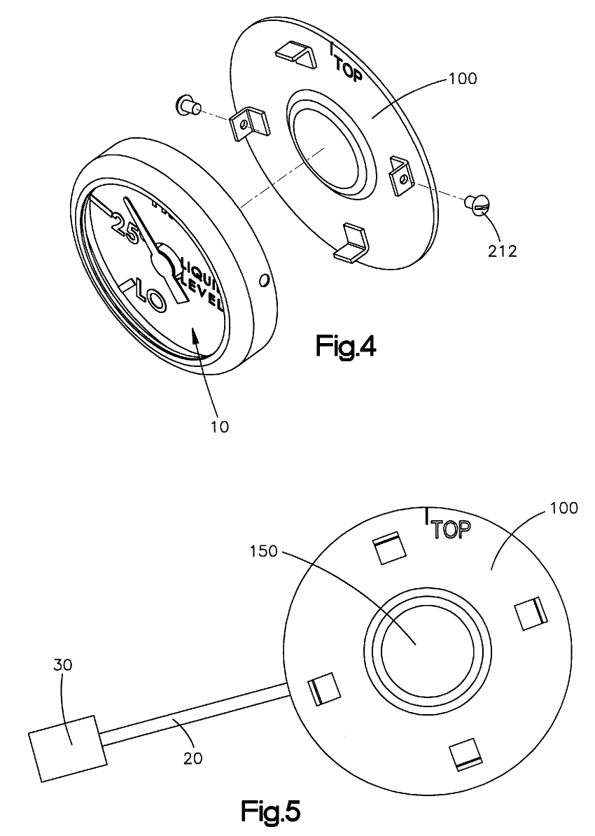

Due to the advantageous structure of certain embodiments of the gauge assembly 1, replacement of a conventional gauge assembly is facilitated. As shown in FIGS. 1-2, a conventional gauge assembly 2 may include a conventional gauge assembly 10 attached to the flange 100, which includes a magnet, by screw fasteners 212. According to an embodiment of the present invention, the screws 212 may be removed thereby permitting the removal of the conventional gauge assembly 10 (FIG. 4), and exposing of the flange 100 (FIGS. 4, 5) and the mounting ears 110 there on. After the gauge assembly 10 has been removed, an adapter 200 (FIGS. 6, 7), in which an electronic circuit 250 is preferably mounted and which is sized and configured to match the flange 100, can be attached to the flange 100. The adapter 200 is preferably attached to the flange using the mounting ears 110 of the flange and the screws 212 which preferably match the support mounting elements 210 (FIG. 3). Thereafter, a display assembly 300, preferably including a magnet that is stronger than the magnet in the flange, is secured to the adapter 200 (FIGS. 8, 9). The securing of the display assembly 300 to the adapter 200 is preferably performed using the fastening elements of the support 220 and the gauge 310 together with fasteners 222.

It should be noted that the invention should not be limited to any specific level of coupling, attachment, securing or fastening, used to create the gauge assembly 1. The flange 100, adapter 200, electronic circuit 250, and display assembly 300, may be coupled, attached, secured, or fastened, to one in another in any way known, or hereafter developed, for example, screws, nails, nuts and bolts, and/or adhesives may be utilized alone, together or in combination. Similarly, the method of replacing the gauge assembly 100 with the gauge assembly 1 should not be limited by the fastening elements or fasteners used in connecting the flange 100 and the gauge assembly 10, or in attaching the gauge assembly 1 to the flange 100. Furthermore, although discussed with reference to a side-mounted gauge assembly mounted to a tank, the present invention may be used with any gauge assembly mounted on any liquid container so long as the gauge assembly includes a flange housing a magnet that is displaced in reaction to a change in the level of liquid in the container.

We claim:

1. A gauge assembly for measuring an amount of a liquid contained in a tank, for use with a float arm assembly that includes a float arm partially disposed within the tank and configured to pivot in response to a change in the level of liquid in the tank, and a flange housing a first magnet and coupled to the float arm such that the movement of the float arm causes a displacement of the first magnet in response to the movement of the float arm, the gauge assembly comprising:
a support that is adapted to be attached to the flange, the support including a second magnet, spaced in relationship to the first magnet and having a different strength than the first magnet;
an electronic circuit positioned proximate to the first magnet and the second magnet to provide a signal representative of the position of the second magnet, wherein the second magnet is displaced by the displacement of the first magnet to show the change of the level of liquid in the tank; and
a display associated with the second magnet for showing the level of liquid in response to the position of the second magnet.

2. The gauge assembly of claim 1, wherein the support comprises an adapter supporting the electronic circuit between the first magnet and the second magnet and a display assembly supporting the second magnet and the display.

3. The gauge assembly of claim 1, wherein first magnet is stronger than the second magnet.

4. The gauge assembly of claim 1, wherein the second magnet is stronger than the first magnet.

5. The gauge assembly of claim 4, wherein the electronic circuit is positioned over the support and the first magnet and the second magnet.

6. The gauge assembly of claim 5, wherein the support comprises a display assembly supporting the second magnet and the display and the electronic circuit is positioned over the display.

7. The gauge assembly of claim 4, wherein the second magnet is a rare earth neodymium magnet.

8. The gauge assembly of claim 1, wherein the electronic circuit is disposed closer to the second magnet.

9. The gauge assembly of claim 1, wherein, the support is attached to the flange using screws.

10. The gauge assembly of claim 2, wherein display assembly is secured to the flange using screws.

11. The gauge assembly of claim 1 further comprising a cable coupled to the electronic circuit, wherein the electronic circuit provides the signal via the cable.

12. The gauge assembly of claim 1, wherein the display is an analog display.

13. The gauge assembly of claim 2, wherein the support minimizes the distance between the flange and the display assembly.

14. A method of improving a gauge assembly for measuring an amount of liquid contained in a tank, the gauge assembly including a float arm partially disposed within the tank and configured to pivot in response to a change in the level of liquid in the tank, and a flange housing a first magnet and coupled to the float arm such that the movement of the float arm causes a displacement of the first magnet in response to the movement of the float arm, and a gauge assembly secured to the flange, the method comprising the steps of:
unsecuring the gauge assembly from the flange;
attaching an adapter to the flange, wherein the adapter is adapted to be attached to the flange and includes an electronic circuit mounted thereon;
securing a display assembly to the adapter, the display assembly including,
a second magnet spaced in relationship to the first magnet, and having a different strength than the first magnet, the second magnet being displaced by the displacement of the first magnet, to show the change of the level of liquid the a tank, and
a display associated with the second magnet for showing the level of the liquid in response to the position of the second magnet; and
wherein the electronic circuit is disposed closer to the second magnet, between the first and the second magnets, and detects the position of the second magnet, and provides a signal representative of the position of the second magnet.

15. The method of claim 14, wherein the second magnet is stronger than the first magnet.

16. The method claim 15, wherein the second magnet is a rare earth neodymium magnet.

17. The method of claim 14, wherein, the adapter is attached to the flange using screws.

18. The method of claim 14, wherein the display assembly is secured to the flange using screws.

19. The method of claim 14, wherein the adapter further includes a cable coupled to the electronic circuit and the electronic circuit provides the signal via the cable.

20. The method of claim 14, wherein the display is an analog display.

21. The method of claim 14, wherein the adapter minimizes the distance between the flange and the display assembly.
